(19) United States
(12) Patent Application Publication
(10) Pub. No.: US 2025/0047151 A1
(43) Pub. Date: Feb. 6, 2025

(54) STATOR FOR AN AXIAL FLUX MACHINE

(71) Applicant: Schaeffler Technologies AG & Co. KG, Herzogenaurach (DE)

(72) Inventors: Henrik Mengelkamp, München (DE); Michael Menhart, Igling (DE); Richard Bernauer, Weilheim (DE)

(73) Assignee: Schaeffler Technologies AG & Co. KG, Herzogenaurach (DE)

(21) Appl. No.: 18/717,124

(22) PCT Filed: Oct. 20, 2022
(86) PCT No.: PCT/DE2022/100774

§ 371 Date: Jun. 6, 2024

(30) Foreign Application Priority Data
Dec. 8, 2021 (DE) 10 2021 132 325.8

(51) Int. Cl. H02K 1/18; H02K 1/14

(52) U.S. Cl. CPC H02K 1/182; H02K 1/14

(57) ABSTRACT

At least two pole shoe segments are associated with a stator tooth in the stator of an axial flux machine; the pole shoe segments are spaced apart from each other. In particular, each pole shoe segment can cover both a part of a stator tooth and a part of a groove for stator windings.

### CROSS-REFERENCE TO RELATED APPLICATIONS

This application is the U.S. National Phase of PCT Appln. No. PCT/DE2022/100774, filed Oct. 20, 2022, which claims priority to German Patent Application No. 10 2021 132 325.8, filed Dec. 8, 2021, the entire disclosures of which are incorporated by reference herein.

### TECHNICAL FIELD

The disclosure relates to electric drives, more specifically axial flux machines, and in particular to the design of the stator.

### BACKGROUND

Electric machines are used for driving purposes in a wide variety of technical fields and, more recently, increasingly for driving motor vehicles. The axial flux machine is one example of the many different ways in which electric motors can be designed. In this type of machine, during operation, one or more rotors rotate relative to one or more stators that are stationary with respect to an installation environment of the axial flux machine. Here, the rotor(s) and stator(s) are arranged consecutively in an axial direction. Permanent magnets are often used in the rotor. The magnetic flux of the stator is usually generated by means of an electric current, which is conducted through windings (stator windings) arranged in grooves between stator teeth. Pole pieces are used to influence the course of the magnetic field.

One known way of forming the pole pieces is to already shape their geometry when stamping the laminated cores for the stator. The windings are fitted at a later time. In this case, the existing pole piece geometry can make assembly more difficult. Alternatively, the pole pieces are manufactured separately, the windings are attached to the stator first, and only then are the pole pieces attached to the stator; this is often done by means of an adhesive. Such an adhesive connection must be designed to withstand the thermal and mechanical loads that occur during operation of the electric machine. Losses can occur in the pole pieces themselves.

### SUMMARY

It is the object of the disclosure to provide a stator for an axial flux machine in which at least some of the disadvantages associated with pole pieces are mitigated or eliminated.

This object is achieved by a stator having one or more of the features disclosed herein. An axial flux machine having such a stator is also disclosed. Advantageous embodiments are described below and in the claims.

The stator for an axial flux machine according to the disclosure has a plurality of stator teeth in a known manner. According to the disclosure, at least two pole piece segments spaced apart from one another are associated with a stator tooth. In particular, this means that the pole piece segments associated with a stator tooth do not contact one another. The use of several pole piece segments per stator tooth instead of a single large-area pole piece per stator tooth reduces the forces acting on the pole piece segments during operation compared to the forces acting on a large-area pole piece. This makes it easier to fix the pole piece segments in the stator. The use of pole piece segments also reduces the losses occurring within the pole piece segments compared to the losses in a large-area pole piece, which increases the efficiency of the electric machine. The use of pole piece segments instead of a large-area pole piece further reduces the amount of material required for the pole piece segments compared to the pole piece. As the pole piece segments are manufactured separately, it is easier to assemble the stator windings than if the pole piece geometry had already been formed during the stamping of stator laminations. Pole piece segments are preferably used on each stator tooth of the stator. The pole piece segments can be made from the same materials that are used to manufacture known pole pieces.

In the context of this application, the azimuthal direction is understood to be the direction in which a rotor of the axial flux machine moves relative to a stator of the axial flux machine during its operation. This movement is a rotary movement. The direction of the axis of rotation of this rotary movement defines the axial direction. The radial direction is perpendicular to both the axial direction and the azimuthal direction.

Preferably, the pole pieces associated with a stator tooth are designed and arranged such that a pole piece segment extends in the azimuthal direction both over a part of the stator tooth and over a part of a groove for stator windings, which groove follows the stator tooth in the azimuthal direction or precedes the stator tooth. In particular, each pole piece segment associated with a stator tooth can extend over a part of the stator tooth as well as a part of a groove in the manner mentioned above. In this way, the pole piece segments are, in particular, able to capture undesired stray magnetic fields occurring at the edges of the stator tooth and improve the course of the magnetic flux in such a way that the additional losses in the stator windings caused by current displacement are significantly reduced. It is also conceivable to use pole piece segments of different sizes within a stator in order to achieve further improvements.

In a further development, a recess for conducting a fluid is provided in a pole piece segment on a side of the pole piece segment facing the groove. For example, an electrically insulating coolant can be used as the fluid; this could be an oil, for example.

In the case of a pole piece segment extending over a part of the groove in the above sense, this can be designed in such a way that it tapers towards the groove. This improves the course of the magnetic field.

In one embodiment, pole piece segments, which are associated with successive stator teeth in the azimuthal direction, are connected to one another. Here, two such pole piece segments extend over a groove, which is flanked by the two successive stator teeth, each of which is associated with one of the pole piece segments. These two pole piece segments are connected to one another.

A pole piece segment can be fixed to the stator tooth with which it is associated; for example, the pole piece segment can be glued to the stator tooth, but other attachment options are conceivable. In a further development, a rabbet can be formed on the stator tooth, which serves to receive a part of the pole piece segment.

However, it is also possible to hold the pole piece segments in their intended position relative to the stator tooth with which they are respectively associated without attaching the pole piece segments to the stator tooth. One way of doing this is to use a housing of the stator. This can be a complete housing or a partial housing, such as a cover. The pole piece segments can be attached to the housing, for example can be glued to the housing; it is also possible to partially or fully embed pole piece segments in the housing, for example if the housing is made of a plastic. If the housing is then arranged in a defined manner relative to the stator teeth, the pole piece segments assume defined positions relative to the stator teeth, for example in such a way that a pole piece segment extends in the azimuthal direction over a part of a stator tooth and a part of a groove. In this regard, it is possible for the pole piece segments to be spaced apart from the stator teeth in the axial direction. In addition to a protective function, such a housing can also be used to hold a fluid, such as a cooling medium, in the stator.

The axial flux machine according to the disclosure has at least one stator according to the disclosure of the type described above. The embodiment of a stator according to the disclosure can be used in any type of axial flux machine, for example in axial flux machines which have exactly one stator and one or more rotors, as well as in axial flux machines which have exactly one rotor and one or more stators. If an axial flux machine has more than one stator, each of these stators can be designed according to the disclosure.

### BRIEF DESCRIPTION OF THE DRAWINGS

The disclosure and its advantages are described in more detail below with reference to the accompanying schematic drawings.

FIG. 1 shows an exemplary embodiment of an axial flux machine.

FIG. 2 shows a further exemplary embodiment of an axial flux machine.

FIG. 3 shows a stator core of a stator according to the disclosure with pole piece segments.

FIG. 4 shows a section of a stator according to the disclosure.

FIG. 5 shows a stator core for a stator of an axial flux machine.

FIG. 6 shows a winding for a stator of an axial flux machine.

FIG. 7 shows a section of an exemplary embodiment of a stator according to the disclosure.

FIG. 8 shows a section of an exemplary embodiment of a stator according to the disclosure.

FIG. 9 shows a section of an exemplary embodiment of a stator according to the disclosure.

FIG. 10 shows a cross-section of a pole piece segment.

FIG. 11 shows a cross-section of a pole piece segment.

FIG. 12 shows a cross-section of a pole piece segment.

FIG. 13 shows a section of a stator according to the disclosure.

FIG. 14 shows a section of a stator according to the disclosure.

FIG. 15 shows a section of a housing for a stator according to the disclosure.

FIG. 16 shows a section of a housing for a stator according to the disclosure.

FIG. 17 shows a section of a stator according to the disclosure.

FIG. 18 shows a section of a stator according to the disclosure.

### DETAILED DESCRIPTION

The figures merely represent exemplary embodiments.

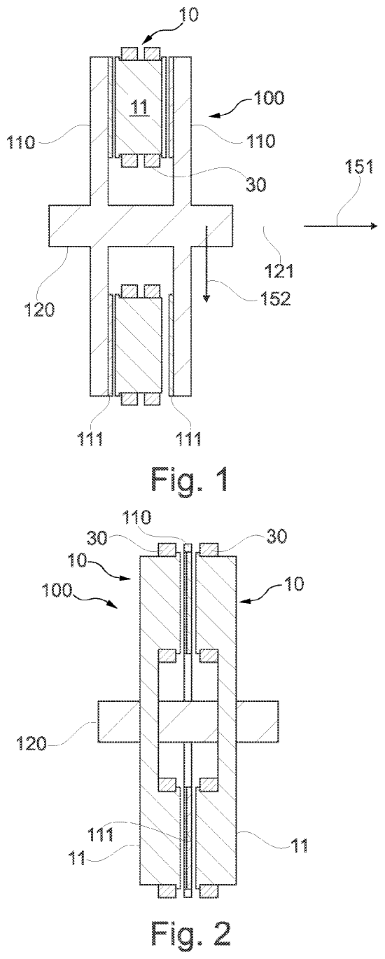

FIG. 1 shows an embodiment of an axial flux machine 100 with a stator 10 arranged between two rotors 110, which are connected by a common rotor shaft 120. Such a configuration of an axial flux machine is also referred to as an H configuration. Permanent magnets 111 are provided on the rotors 110. During operation of the axial flux machine 100, the rotors 110 rotate relative to the stator 10 about the axis of rotation 121, the direction of which defines the axial direction 151. The direction of this rotary movement itself is perpendicular to the drawing plane and defines the azimuthal direction here. The radial direction 152 is also shown. The stator 10 comprises a stator core 11, which carries windings 30, for example made of copper. The stator core 11 can be formed in a known manner, for example from stacks of stamped sheet metal.

FIG. 2 shows an embodiment of an axial flux machine 100 with a rotor 110 arranged between two stators 10. Such a configuration of an axial flux machine is referred to as an I-configuration. The rotor 110 sits on a rotor shaft 120 and is provided with permanent magnets 111. Each of the stators 10 comprises a stator core 11 which carries windings 30.

Both in the embodiment shown in FIG. 1 and in FIG. 2, the stators 10 can be designed according to the disclosure. However, stators can also be used in other configurations of an axial flux machine.

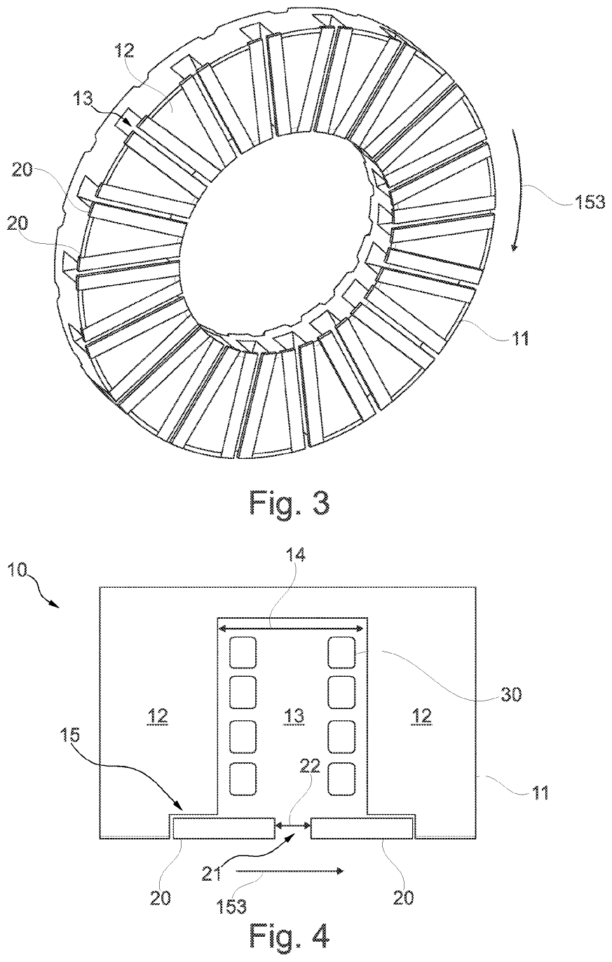

FIG. 3 shows a stator core 11 with stator teeth 12. Grooves 13 are provided between the stator teeth 12, which are used to receive stator windings. Each stator tooth 12 carries two pole piece segments 20. In the azimuthal direction 153, each pole piece segment 20 extends over a part of the respective stator tooth 12 and a part of the groove 13 following or preceding this stator tooth 12 in the azimuthal direction 153. The pole piece segments 20 are spaced apart from one another, in particular they do not contact one another. In relation to a stator tooth 12, the two pole piece segments 20 according to the disclosure take the place of a single pole piece for the stator tooth, which covers the latter over a large area, generally over the entire end face.

FIG. 4 shows a section of a stator 10 with a stator core 11. A groove 13, in which stator windings 30 are arranged, is flanked in the azimuthal direction 153 by two stator teeth 12. A pole piece segment 20 is shown for each of these stator teeth 12, which extends in the azimuthal direction 153 over a part of the groove 13. A gap 21 is thus formed between the pole piece segments 20, with a gap width 22 which is less than a groove width 14, in each case measured in the azimuthal direction 153. A rabbet 15 is formed on each stator tooth 12, in which a part of the respective pole piece segment 20 is received.

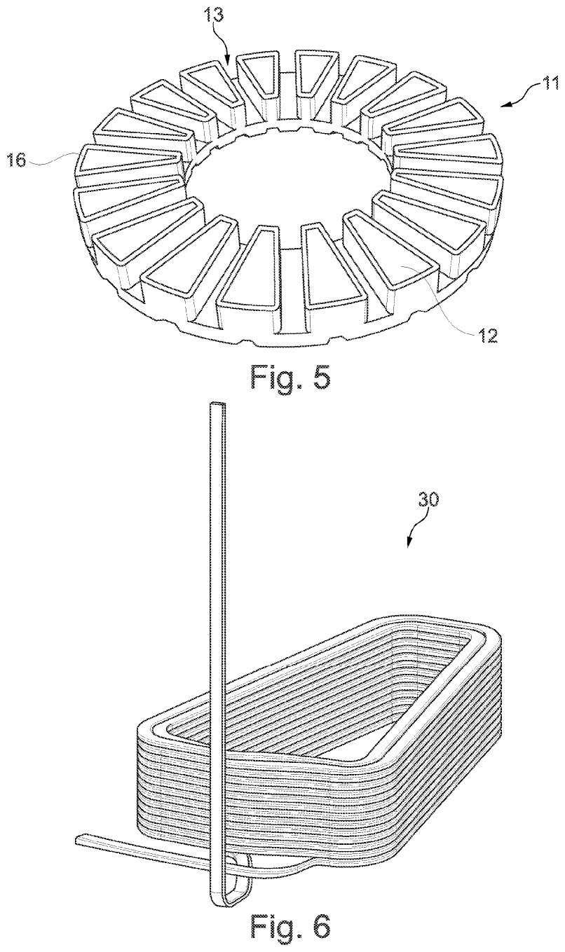

FIG. 5 shows a stator core 11 with stator teeth 12 and grooves 13 provided between the stator teeth 12. The stator core 11 is provided with an electrically insulating layer 16. The use of an electrically insulating layer 16 is common, but this layer is not shown in most of the drawings here for reasons of clarity.

FIG. 6 shows a stator winding 30 that can be used in a stator according to the i disclosure. Such windings are inserted into the stator core 11, such as the one shown in FIG. 5, and run partially in its grooves 13.

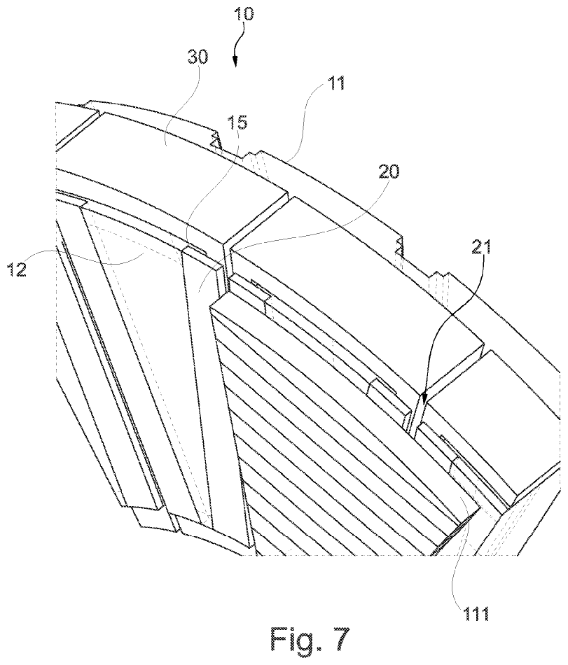

FIG. 7 shows a section of an exemplary embodiment of a stator 10 according to the disclosure. The stator core 11 with stator teeth 12 and windings 30 extending between them are shown. For orientation purposes, a permanent magnet 111 of a rotor of an axial flux machine is also shown in a position in which it can be located when the axial flux machine is assembled. The stator teeth 12 are provided with pole piece segments 20; a rabbet 15 is provided on the respective stator tooth 12 in order to receive a pole piece segment 20 in each case. A gap 21 is formed between two adjacent pole piece segments 20 associated with different stator teeth 12.

In the embodiment shown, the pole piece segments 20 are cuboid, in particular a cross-section with a section plane perpendicular to the radial direction is rectangular.

FIG. 8 shows a section of a further exemplary embodiment of a stator 10 according to the disclosure. The basic structure is analogous to the exemplary embodiment discussed with respect to FIG. 7, so that reference is made to FIG. 7 for the description of most of the elements shown.

In contrast to the embodiment shown in FIG. 7, a recess 23 is provided on the pole piece segments 20 for conducting a fluid. The recess 23 faces the windings 30 and thus one groove 13 in each case. The recess 23 provides more volume in the region of the windings 30 through which a fluid, such as an electrically insulating cooling medium, can be conducted.

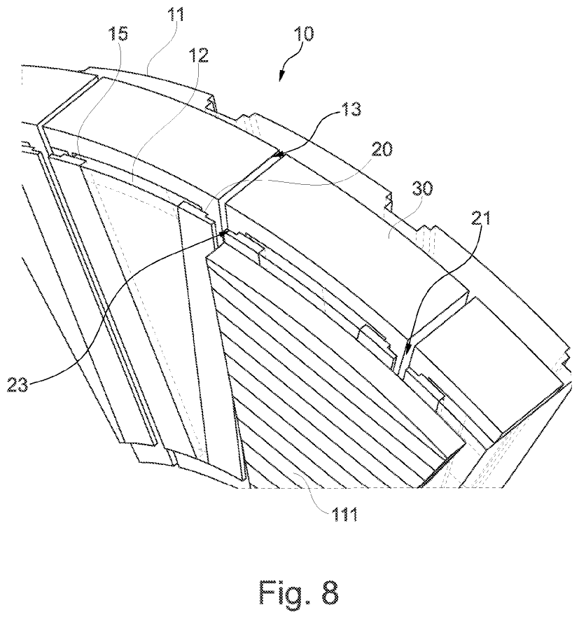

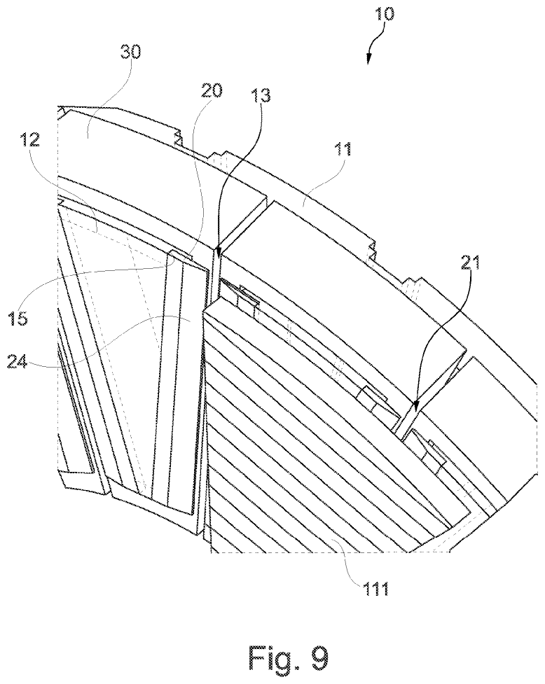

FIG. 9 shows a section of a further exemplary embodiment of a stator 10 according to the disclosure. The basic structure is analogous to the exemplary embodiment discussed with respect to FIG. 7, so that reference is made to FIG. 7 for the description of most of the elements shown.

In contrast to the embodiment shown in FIG. 7, a tapering region 24 is provided on the pole piece segments 20 in each case. Due to this tapering region 24 and the arrangement of the pole piece segments 20, the pole piece segments 20 each taper towards a groove 13 or also towards a gap 21 between adjacent pole piece segments 20 associated with different stator teeth 12.

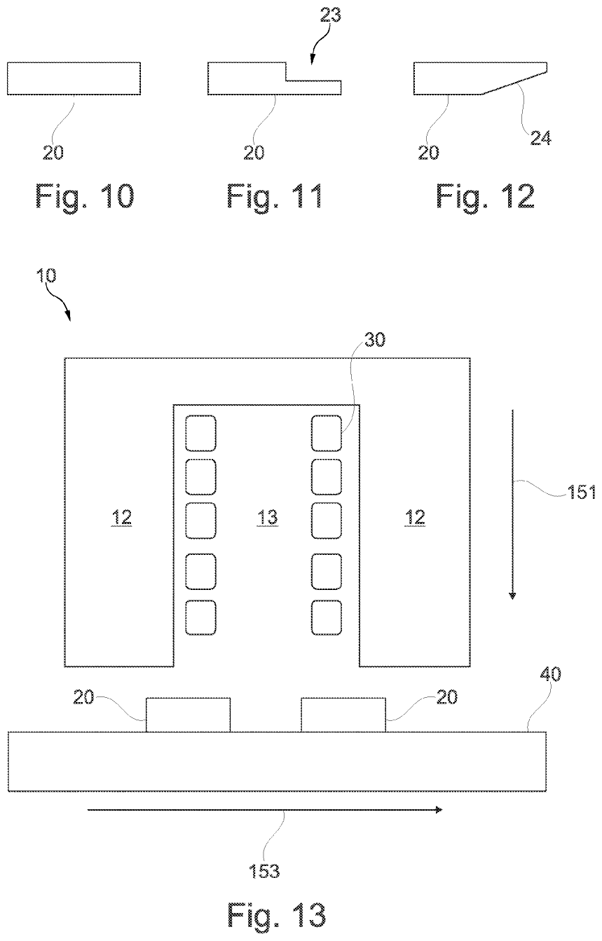

FIGS. 10-12 each show a cross-section of a pole piece segment 20. Here, the section plane is in each case perpendicular to the radial direction, in the case of pole piece segments 20 installed in a stator according to the disclosure. In the exemplary embodiment of FIG. 10, the cross-section is rectangular, as in the exemplary embodiment of FIG. 7. In the exemplary embodiment of FIG. 11, the pole piece segment 20 has a recess 23 for conducting a fluid, as in the exemplary embodiment of FIG. 8. In the exemplary embodiment of FIG. 12, the pole piece segment 20 has a tapering region 24, as in the exemplary embodiment of FIG. 9.

FIG. 13 shows a section of a stator 10 according to the disclosure. A groove 13, in which windings 30 are arranged, is flanked in the azimuthal direction 153 by two stator teeth 12. A pole piece segment 20 is shown for each of these stator teeth 12, which extends in the azimuthal direction 153 over a part of the groove 13. Similarly, each pole piece segment 20 extends in the azimuthal direction 153 over a part of the respective stator tooth 12. The pole piece segments 20 are spaced apart from the stator teeth 12 in the axial direction 151, in particular they are not attached to the stator teeth 12. The pole piece segments 20 are attached to a housing 40 for the stator 10; only a section of the housing 40 is shown here.

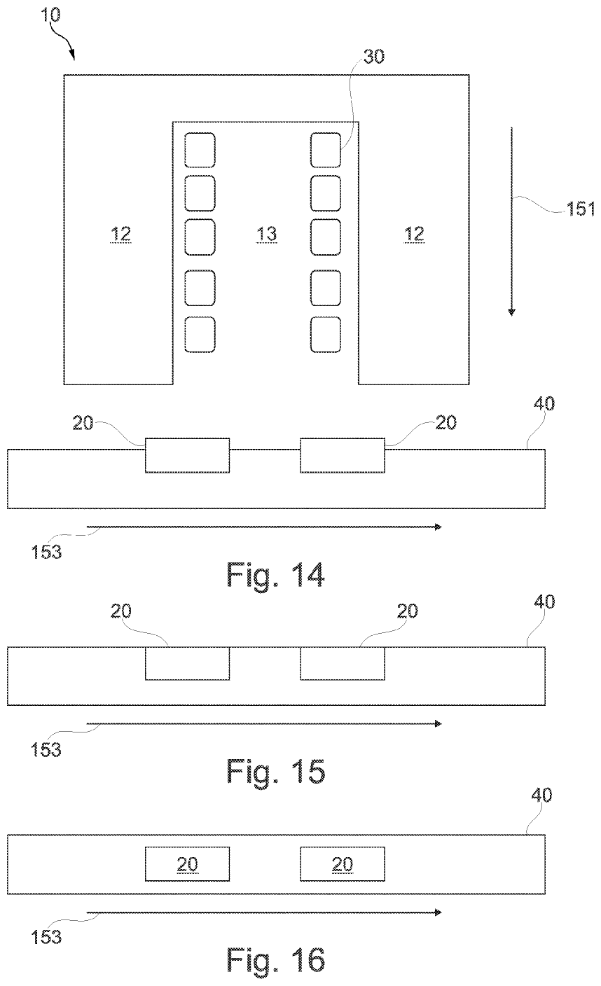

FIG. 14 shows a section of a stator 10 according to the disclosure, largely similar to the embodiment shown in FIG. 13. In contrast to the embodiment shown in FIG. 13, here the pole piece segments 20 are partially embedded in a housing 40 for the stator 10. For example, the housing 40 can be a fiber composite part, and the pole piece segments 20 can be embedded, such as laminated, in the housing 40. Embodiments are also conceivable in which the pole piece segments 20 are completely embedded in the housing 40, so that the pole piece segments 20 do not protrude from the housing 40. This is shown in FIGS. 15 and 16. FIG. 15 shows only a section of the housing 40 and the azimuthal direction 153 for orientation. The pole piece segments 20 are embedded in the housing 40 in such a way that they are flush with the housing 40. FIG. 16 is analogous to FIG. 15, except that here the pole piece segments 20 are embedded in the housing 40 in such a way that they are completely enclosed by the material of the housing 40.

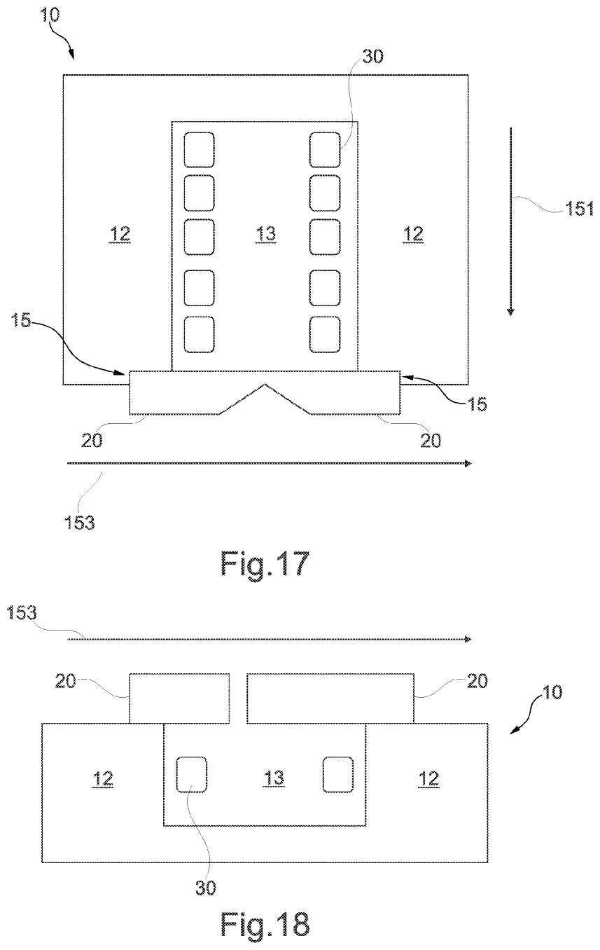

FIG. 17 shows a section of a stator 10 according to the disclosure. A groove 13, in which windings 30 are arranged, is flanked in the azimuthal direction 153 by two stator teeth 12. A pole piece segment 20 is shown for each of these stator teeth 12, which extends in the azimuthal direction 153 over a part of the groove 13. Similarly, each pole piece segment 20 extends in the azimuthal direction 153 over a part of the respective stator tooth 12. Each pole piece segment 20 is attached to the respective stator tooth 12 in a rabbet 15. The pole piece segments 20 shown, which are associated with successive stator teeth 12 in the azimuthal direction 153, are connected to one another in this embodiment. In particular, such two interconnected pole piece segments 20 can be manufactured as a single component in one embodiment.

FIG. 18 shows a section of a stator 10 according to the disclosure. A groove 13, in which stator windings 30 are arranged, is flanked by two stator teeth 12. The azimuthal direction 153 is also shown. Also shown are two pole piece segments 20, which are attached to a respective stator tooth 12. In the embodiment shown, the pole piece segments 20 have different sizes. Irrespective of this, this example also shows the attachment of the pole piece segments 20 to the stator teeth 12 without using a rabbet.

### LIST OF REFERENCE SYMBOLS

10 Stator
11 Stator core
12 Stator tooth
13 Groove
14 Groove width
15 Rabbet
16 Electrically insulating layer
20 Pole piece segment
21 Gap
22 Gap width
23 Recess
24 Tapering region
30 Winding
40 Housing/cover
100 Axial flux machine
110 Rotor
111 Permanent magnet
120 Rotor shaft
121 Axis of rotation
151 Axial direction
152 Radial direction
153 Azimuthal direction

1. A stator for an axial flux machine, the stator comprising:
a plurality of stator teeth; and
at least two pole piece segments spaced apart from one another are associated with each of the stator teeth.

2. The stator according to claim 1, wherein the pole piece segments associated with each of the stator teeth are arranged such that one of the pole piece segments extends in an azimuthal direction both over a part of the stator tooth and over a part of a groove for stator windings, said groove follows the stator tooth in the azimuthal direction or precedes the stator tooth.

3. The stator according to claim 2, further comprising a recess for conducting a fluid in one of the pole piece segments on a side of the pole piece segment facing the groove.

4. The stator according to claim 3, wherein the one of the pole piece segments tapers towards the groove.

5. The stator according to claim 1, wherein the pole piece segments, which are associated with successive ones of the stator teeth, are connected to one another.

6. The stator according to claim 1, wherein one of the pole piece segments is attached to an associated one of the stator teeth.

7. The stator according to claim 6, further comprising wherein a rabbet on the stator tooth for receiving a part of the pole piece segment.

8. The stator according to claim 1, further comprising a housing for the stator, and at least one of the pole piece segments is attached to the housing and/or embedded in the housing.

9. The stator according to claim 1, wherein pole piece segments of the stator differ in size.

10. An axial flux machine comprising at least one of the stators according to claim 1.

11. A stator for an axial flux machine, the stator comprising:
a stator body including a plurality of stator teeth, each of the stator teeth having a rotor facing end; and
at least two pole piece segments spaced apart from one another connected to the rotor facing end of each of the stator teeth.

12. The stator according to claim 11, wherein the pole piece segments associated with each of the stator teeth are arranged such that one of the pole piece segments extends in an azimuthal direction both over a part of the stator tooth and over a part of a groove for stator windings, said groove follows the stator tooth in the azimuthal direction or precedes the stator tooth.

13. The stator according to claim 12, further comprising a recess for conducting a fluid in one of the pole piece segments at each of the grooves on a side of the pole piece segment facing the groove.

14. The stator according to claim 13, wherein the one of the pole piece segments at each of the grooves tapers towards the groove.

15. The stator according to claim 11, wherein the pole piece segments, which are associated with successive ones of the stator teeth, are connected to one another.

16. The stator according to claim 11, wherein the pole piece segments extend radially from an inner periphery of the stator to an outer periphery of the stator.

17. The stator according to claim 11, further comprising wherein a rabbet on each of the stator teeth for receiving a part of the respective pole piece segment.

18. The stator according to claim 11, wherein pole piece segments of the stator differ in size.
